(19) United States
(12) Patent Application Publication
(10) Pub. No.: US 2008/0041386 A1
(43) Pub. Date: Feb. 21, 2008

(54) Transportable device for storing and delivering oxygen

(76) Inventors: Philippe Dodier, Lyon (FR); Eliette Ferre, Bussy Saint Georges (FR); Joseph Mazoyer, Sainte Foy Les Lyon (FR); Eric Sermet, Bussy Saint Georges (FR); Frederic Malboze, Quincy Voisins (FR); Gautier Vadon, Bussy Saint Georges (FR)

Correspondence Address: YOUNG & THOMPSON, 745 SOUTH 23RD STREET, 2ND FLOOR, ARLINGTON, VA, 22202, US

(21) Appl. No.: 11/545,525

(22) Filed: Oct. 11, 2006

(30) Foreign Application Priority Data
Aug. 16, 2006 (FR) 06 53376

(51) Int. Cl. A62B 9/00

(52) U.S. Cl. 128/205.22

(57) ABSTRACT

Transportable device for storing and delivering oxygen includes a casing containing a cryogenic tank, a heating circuit connected to the tank including at least one member for heating/vaporizing the oxygen originating from the tank for the purpose of its being supplied to a user, a circuit for filling the cryogenic tank including a fluidic connection member designed to be connected, in a filling direction, to a matching connector of a liquid oxygen reserve, a venting valve connected inside the tank, a manually actuated movable member for controlling the venting valve, the control member being movable relative to the casing for actuating the valve via a system for transmitting movement between closed and open positions of the venting valve so in moving from closed to open positions, the control member describes a movement having at least one component oriented substantially towards the inside of the casing and/or in the filling direction.

The invention relates more particularly to a transportable device for storing and delivering oxygen comprising a casing containing a cryogenic tank designed to contain liquid oxygen, a heating circuit connected to the tank comprising at least one member for heating/vaporizing the oxygen originating from the tank for the purpose of its being supplied to a user, a circuit for filling the cryogenic tank comprising a fluidic connection member such as a male or female filling connector designed to be connected, in a filling direction, to a matching connector of a liquid oxygen reserve, a venting valve connected inside the tank, a manually actuated movable member for controlling the venting valve, the control member being movable relative to the casing for actuating the venting valve via a system for transmitting movement between closed and open positions of the said valve.

Such transportable devices for storing and delivering oxygen are usually carried by the users by means of a strap or bandolier. These devices, usually called a “portable oxygen reserve”, are designed to be connected to the breathing system of the patient, for example by means of a dual nozzle that can be connected to the nostrils of the patient. These portable devices must therefore accompany the user in his everyday movements.

When the portable device is empty, the user fills it by connecting it to a fixed reserve having a larger liquid oxygen storage capacity. Such a storage tank system and portable tank is described in document U.S. Pat. No. 4,211,086.

Conventionally, the opening of the venting valve is controlled manually by a pivoting lever positioned in the lower portion of the portable element. To fill the portable element, the user must simultaneously press the portable element onto the reserve to cause the filling connector to open and pull the venting valve control lever. This combination of operations is however relatively difficult for such a patient because it requires coordination of two distinct movements with relatively large forces. In addition, because of the impractical arrangement of the valve control member, the user often tends to exert an excessive force on the valve actuation member. This frequently causes a deformation of the venting valve shaft and therefore a reduction in the lifetime of the said valve.

In addition, the known systems are usually ill-suited in terms of ergonomics and manoeuvrability for patients afflicted with short breath and in particular for old people. The weight of these portable systems is usually more than 1.5 kg which may be a very large load for these patients.

An object of the invention is to propose to alleviate some or all of the disadvantages of the prior art.

This object is achieved by the fact that the transportable device for storing and delivering oxygen according to the aforementioned preamble is essentially characterized in that, in its movement from the closed position to the open position, the control member describes a movement having at least one component oriented substantially towards the inside of the casing and/or in the filling direction.

Furthermore, the invention may comprise one or more of the following features:
in its actuation from the closed position to the open position, the control member and/or the system for transmitting movement generates a force on the device having at least one component oriented in the filling direction,
in its movement from the open position to the closed position, the control member describes a movement oriented substantially towards the outside of the casing and/or opposite to the filling direction,
the control member is movable in rotation and/or in translation relative to the casing,
the control member comprises a lever articulated relative to the casing,
the lever is articulated relative to the casing at a first end and comprises a second, free end,
the lever is connected to the venting valve by a system for transmitting movement in order to form a lever arm for actuating the said valve when the lever is rotated,
the device comprises a removable element for immobilizing the movable lever between a position allowing the rotation of the lever and a position preventing the rotation of the lever,
the removable element for immobilizing the lever comprises a stop that can be moved relative to the casing capable of interacting or not interacting with the second end of the lever, the movable stop being connected to a gripping portion,
the device comprises a return member forcing the means for immobilizing the lever to the position preventing the rotation of the lever,
the control member comprises a sleeve capable of sliding around at least a portion of the casing between high and low positions corresponding respectively to a closure and an opening of the venting valve, the high and low positions being defined relative to the upper and lower portions of the casing, the device also comprising a return member forcing the sleeve to its high position,
the casing comprises at least one portion flared in the direction of its lower portion and in that the control member is situated at least partially at the level of the flared-portion,
the fluidic connection member is situated in the lower portion of the device,
the fluidic connection member is situated in the lower portion of the casing designed to come facing the pedestal,
the fluidic connection member forming a connector for filling the tank is oriented in the filling direction,
the articulation shaft of the lever is substantially perpendicular to the vertical axis of the device,
the first and second ends of the lever are situated at different heights along the vertical axis of the device,
the first end of the lever is situated above the second end of the lever relative to the top and bottom ends of the casing,
the lever is articulated at its lower end to allow the lever to pivot towards the outside of the casing towards the filling direction,
the device comprises a second handling grip which coincides at least partially with the zone of the casing comprising the member for controlling the venting valve,
the second handling grip has a structure that can move between a retracted position and a deployed position and return means forcing the grip to its retracted position,
the control member comprises a button that can be moved in translation relative to the casing,
the device comprises a pedestal furnished with at least one rolling member to allow the device to be moved by rolling, the pedestal and the casing comprising combined coupling members that can be moved between an active position for locking the casing onto the pedestal and an inactive position for separating the casing from the pedestal,
the combined coupling members formed respectively on the pedestal and the casing comprise a system with a mobile part and a housing forming a stop for the said mobile part, the mobile part being movable between a position of interaction with the housing and a retracted position of non-interaction with the housing,
the device comprises a control member coupled to the coupling members, the control member being movable between a first position pressing on the combined coupling members in an active position of locking the casing to the pedestal and a second position pressing on the combined coupling members in an inactive position for separating the casing from the pedestal,
the device comprises a return element forcing the control member towards its first position,
the control member comprises a button or a pedal,
the control member is situated on the pedestal,
the control member is mechanically connected to at least one portion of the coupling members,
the combined coupling members comprise at least one movable hook fixedly attached to the pedestal and a combined housing formed in the bottom portion of the casing,
the combined coupling members comprise a first movable hook and a second fixed hook fixedly attached to the pedestal and two combined housings formed in the bottom portion of the casing and designed to interact respectively with the two hooks,
the bottom portion of the casing comprises at least one opening, the top surface of the pedestal having a concave volume forming a zone for collection of the condensates generated by the oxygen heating/vaporization members,
the pedestal comprises a bearing zone capable of resting on the ground and the portion of the pedestal designed to receive the casing being situated substantially between the bearing zone and the portion of the pedestal provided with the rolling member in order to allow, on the one hand, the stable retention of the device on the bearing zone and the rolling member and, on the other hand, the pivoting and the rolling of the device on the rolling member,
the tank and a first heating/vaporization member are placed in the bottom portion of the casing, a second heating/vaporization member being placed in the top portion of the casing above the tank and the first heating/vaporization member,
the control member of the coupling system is fixedly attached to the mobile part,
the rolling member comprises two parallel wheels or rollers mounted on a common axle,
the zone for collecting the condensates comprises an element for absorbing humidity such as an interchangeable piece of felt,
the device comprises a system of adjusting the flow of oxygen delivered by the device comprising an operating button placed in the top portion of the casing,
the device comprises a system of measuring and displaying the level of fluid contained in the tank, the level display being located substantially in the mid-portion of the casing,
the device comprises a first handling grip situated in the top portion of the casing,
the first handling grip is fixedly attached to at least one shaft capable of being deployed or retracted relative to the casing via a mechanism such as a telescopic sliding mechanism.

Other features and advantages will appear on reading the following description, made with reference to the figures in which:

FIG. 1 represents a view in perspective of a transportable device for storing and delivering oxygen according to an exemplary embodiment of the invention in the position connected to its rolling pedestal and with a top grip deployed,

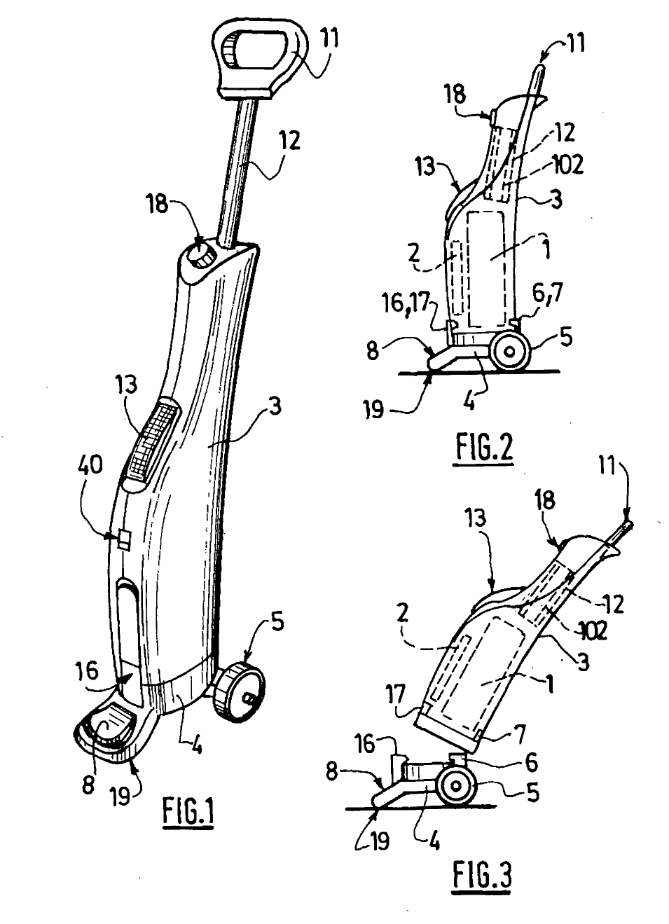

FIG. 2 represents a side view of the device of FIG. 1, the top grip being retracted,

FIG. 3 represents a side view of the device of FIG. 1 in the position disengaged from its rolling pedestal,

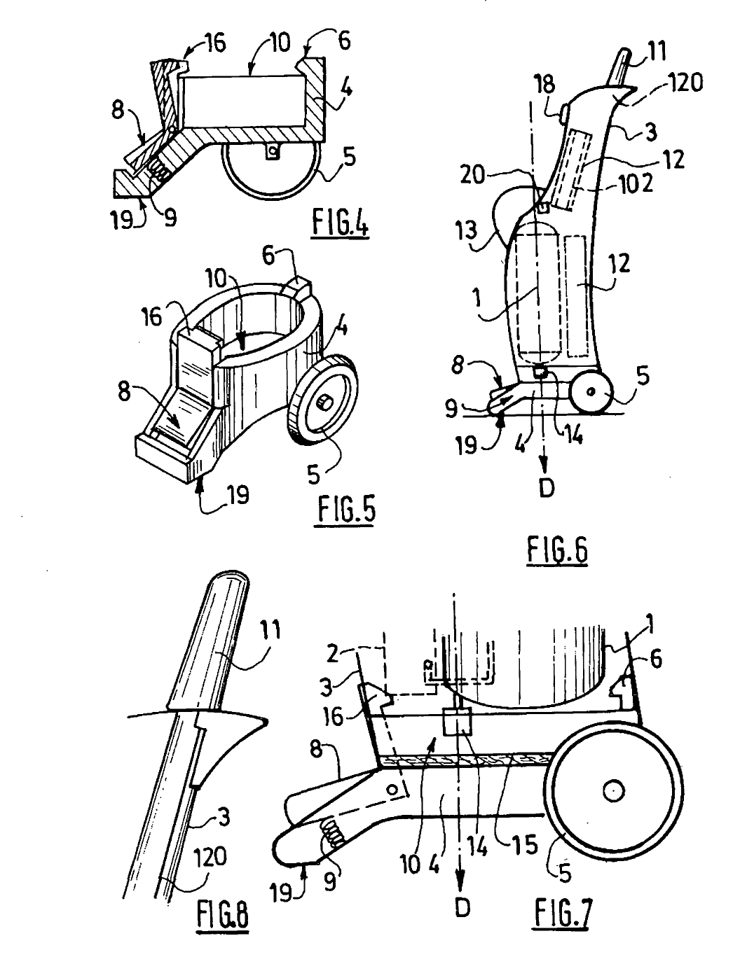

FIGS. 4 and 5 represent respectively views from the side and in perspective illustrating the rolling pedestal portion of the device of FIG. 1,

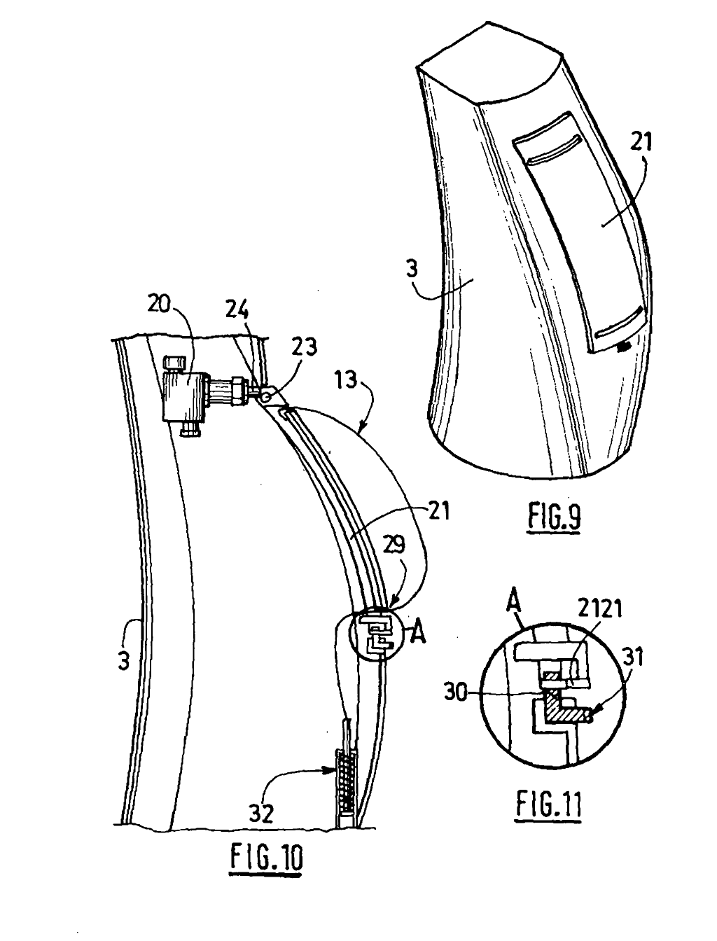

FIG. 6 represents a schematic side view of the device of FIG. 1 according to another exemplary arrangement of the elements for storing and heating the cryogenic fluid inside the device,

FIG. 7 represents an enlarged view of a detail of the device of FIG. 1, illustrating the connection between the base of the device and its rolling pedestal,

FIG. 8 represents an enlarged view of a detail of the device of FIG. 6, illustrating the top telescopic handling grip,

FIG. 9 illustrates a detail of the device for storing and delivering oxygen according to the invention illustrating schematically a portion of its outer casing in another embodiment,

FIG. 10 represents a view in vertical section and from the side of the casing of FIG. 9 illustrating a lever mechanism for controlling the venting valve of the device in the locked, rest position (venting valve closed),

FIG. 11 represents an enlarged view of a detail A of FIG. 10 illustrating a removable mechanism for immobilizing the lever in the rest position,

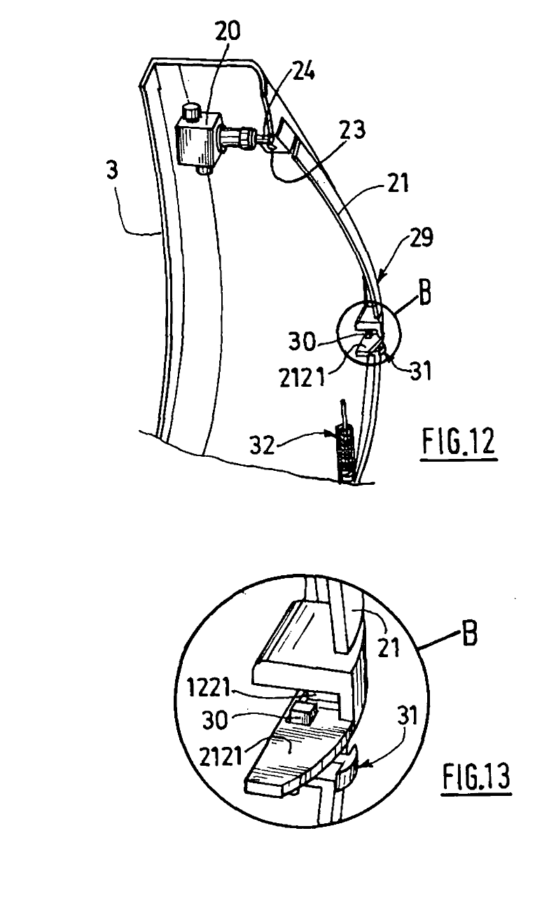

FIGS. 12 and 13 represent views in perspective of the casing corresponding respectively to FIGS. 10 and 11,

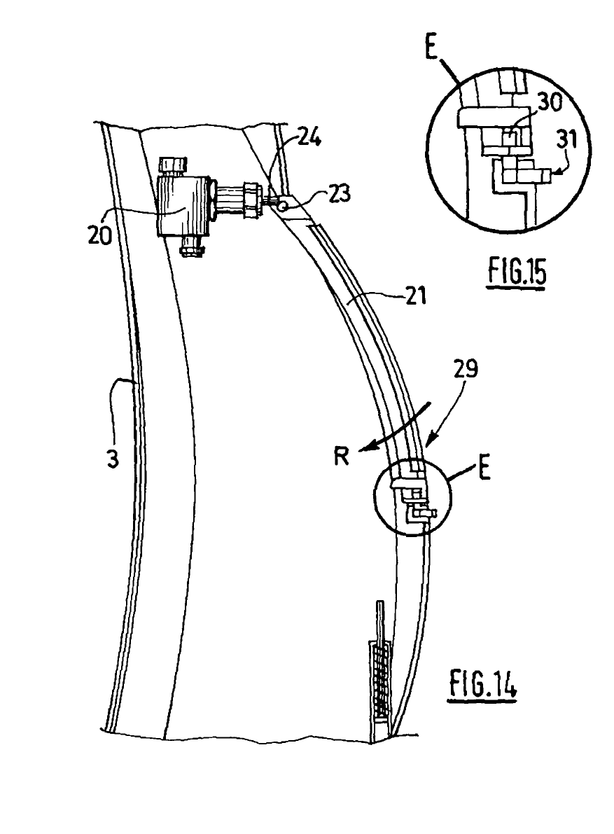

FIGS. 14 and 15 represent views of the casing similar respectively to FIGS. 10 and 11, in which the lever mechanism for controlling the venting valve is in the unlocked position and the lever moving towards its operating position (towards opening of the venting valve),

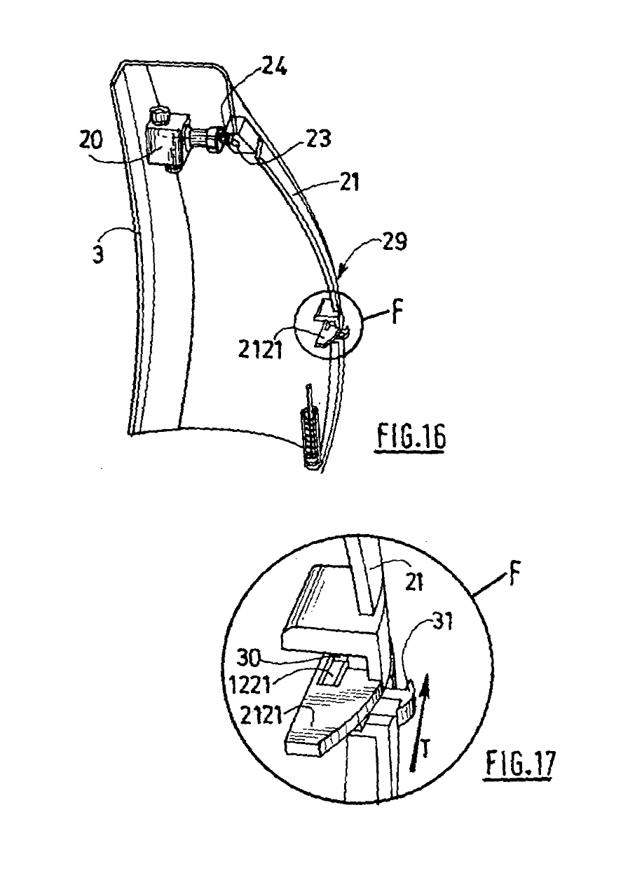

FIGS. 16 and 17 represent views in perspective corresponding respectively to FIGS. 14 and 15,

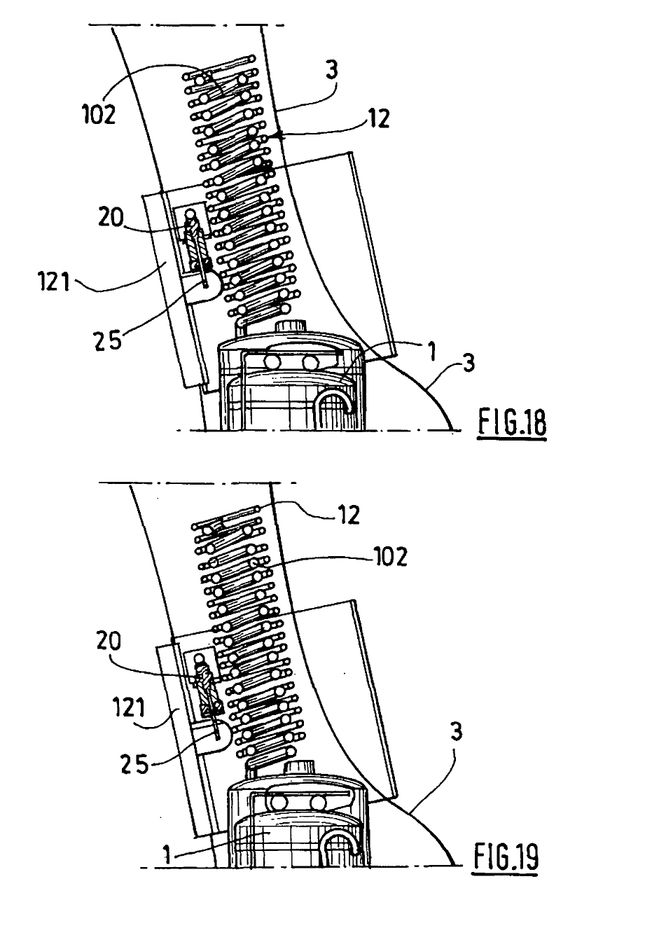

FIGS. 18 and 19 represent schematically a detail of the transportable device for storing and delivering oxygen illustrating a second exemplary embodiment of the venting valve control mechanism, respectively in the closed and open position of the said venting valve,

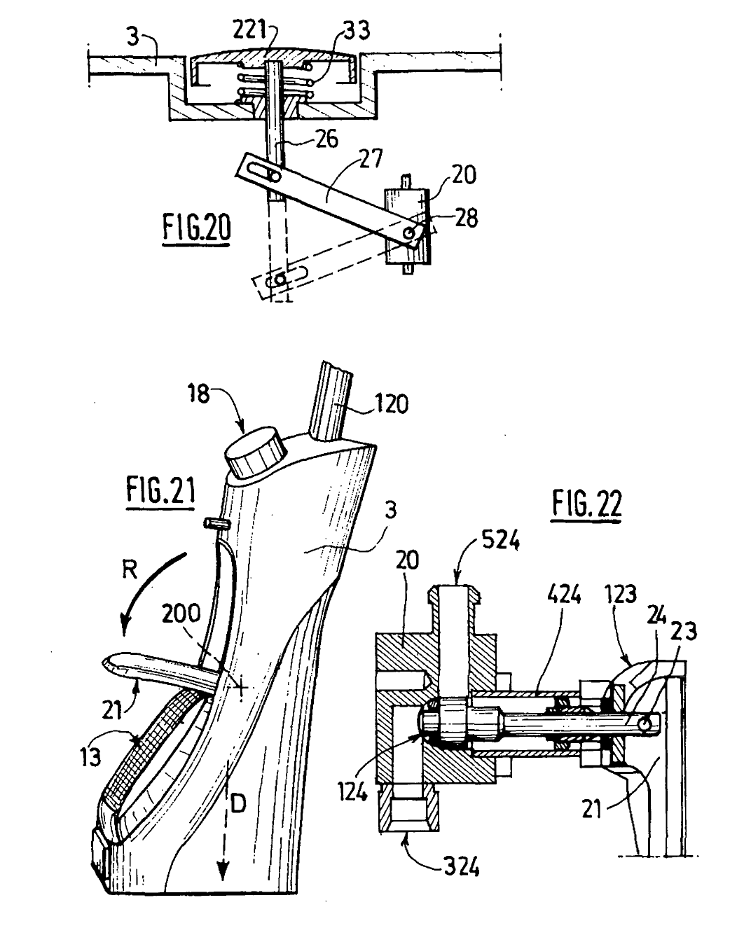

FIG. 20 represents schematically a detail of the transportable device for storing and delivering oxygen illustrating a third exemplary embodiment of the venting valve control mechanism,

FIG. 21 represents a view in perspective of the central portion of a transportable device for storing and delivering oxygen illustrating a fourth exemplary embodiment of the venting valve control mechanism,

FIG. 22 represents a side view of a detail of the device illustrating schematically an example of controlling the venting valve via an articulated lever.

With reference now to FIGS. 1 and 2, the transportable device for storing and delivering oxygen comprises a casing 3 of generally oblong shape narrowing towards its top end. The casing 3 contains a cryogenic tank 1 designed to contain liquid oxygen (in balance with vapour).

The casing 3 also contains a heating circuit connected to the tank 1 (not shown in detail since known per se) comprising, in this example, two coils 2, 12 for heating/vaporizing the oxygen originating from the tank 1 for the purpose of its being supplied to a user (via a dual nozzle for example).

The bottom base of the casing 3 is rendered removably attached to a pedestal 4 furnished with rollers 5 thus allowing movement by rolling the device.

Advantageously, the device may comprise a first handling grip 11 preferably situated in the top portion of the casing 3. Also preferably, and as seen in FIGS. 1, 2 and 8, the first handling grip 11 is fixedly attached to at least one shaft 120 or stem capable of being deployed or retracted relative to the casing 3, for example via a telescopic sliding mechanism or similar that can be housed in the casing 3. In this manner, the top grip 11 may be fitted with a means of adjusting its height, according to the size of the patient. Preferably, the shaft 120 has a rectangular, square or similarly non-circular section interacting with a matching guide. In this manner, the alignment of the grip 11 relative to the casing 3 is assured. In addition, such a retractable geometry of the shaft 120 makes the operation of rolling easier by preventing in particular the shaft 120 from twisting along its length.

In its mid-portion, the casing 3 may comprise a second handling grip 13. As can be seen in FIG. 10, the second handling grip 13 may have a structure that can be moved between a retracted position and a deployed position and a return member 32 forcing the grip 13 towards its retracted position. For example, the second grip 13 comprises a strap of which one end (for example the bottom) is connected to a spring system 32 situated in the casing 3. The spring system 32 pulls and retracts at least a portion of the strap 13 into the volume of the casing 3 when it is not used for carrying the device.

This spring system 32 may be associated with a mechanism for measuring the weight of the transportable device when it is pulled. That is to say that when the user carries the device by the deployable/retractable strap 13, the spring 32 is acted upon according to the weight of the device. The measurement of the level of liquid in the tank 1 may thus be correlated with a means of measuring the tension of the spring 32. This measurement reflects the level of liquid in the tank 1. The display 40 of this level is located preferably substantially in the mid-portion or bottom portion of the casing 3. The arrangement of the weights in the casing 3 (tank 1 and circuits 2 in particular) and the position of the display 40 may make it easier to read the level 40 by a natural tilting of the assembly when the device is carried by the strap 13. That is to say that the face of the casing 3 provided with the display 40 faces upwards, towards the user.

The second grip 13 is perfectly incorporated into the mid-zone of the casing 3, which allows it to be grasped in any position of the system.

According to an advantageous feature, the rolling pedestal 4 and casing 3 comprise combined coupling members 6, 16; 7, 17 making it possible selectively to keep the casing 3 on the pedestal 4 or separate them (see FIGS. 2 to 5).

In the exemplary embodiment shown in FIGS. 4 and 5 in particular, the combined coupling members comprise a first hook 16 that can be rotated and a second fixed hook 6 fixedly attached to the pedestal 4 and two matching combined housings 7, 17 formed in the bottom portion of the casing 3 and designed to receive respectively the two hooks 6, 16 of the pedestal.

More precisely, the pedestal 4 has the general shape of a receptacle that is concave, ovoid and open upwards.

The bottom portion of the casing 3 may comprise at least one opening designed to come facing the top concave surface of the pedestal 4. In this manner, the concave zone of the pedestal 4 forms a volume 10 for collecting the condensates generated by the member or members 2, 12 for heating/vaporizing the oxygen situated in the casing 3. The zone 10 for collecting the condensates may thus house an element 15 for absorbing humidity such as an interchangeable piece of felt. The accessibility of this collection zone 10 is easy and fast which makes it easy to change the humidity-absorbing felt regularly.

The two hooks 6, 16 are situated respectively at two ends of the pedestal 4 and have their coupling ends turned towards one another.

The pedestal 4 comprises a member 8 for controlling the movable hook 16 such as an articulated pedal. For example, the pedal 8 for ejecting the casing 3 is rotatably attached to the movable hook 16. Thus, when the user presses on the pedal 8, he causes the movable hook 16 to pivot towards the outside of the casing 3 which then comes out of its housing 17 of the casing 3.

The user may then separate the casing 3 from the pedestal 4 by handling it via the top grip 11. That is to say that the housings 7, 17 for coupling the casing 3 may be separated from the hooks 16 by causing the casing 3 to pivot about its bottom portion.

The casing 3 may thus be easily disconnected from its pedestal 4 without requiring particular effort from the user (it is not necessary to bend). Released from the pedestal, the device may be connected to a reserve for refilling. Preferably, a return element 9 such as a spring acts upon the pedal moving it towards its first position for retaining the movable hook 16 in the position of locking the casing 3 onto the pedestal 4.

Naturally, some or all of the hooks may be formed on the casing and the matching housings on the pedestal 4. Similarly, any other male/female coupling system may be envisaged. In particular, several movable hooks or latches or similar elements may be provided.

As can be seen in FIGS. 1 to 5, the pedestal 4 may comprise a bearing zone 19 capable of resting on the ground. Preferably, the portion of the pedestal 4 designed to receive the casing 3 is situated substantially between the bearing zone 19 and the portion of the pedestal provided with the rollers 5. In this manner, the device may be kept upright in a stable position on the bearing zone 19 and the rollers 5 and may be tilted to roll only on the rollers 5.

The pedestal 4 comprises for example two parallel wheels 5 or rollers mounted on a common axle perpendicular to the direction in which the casing 3 is mounted on the pedestal 4.

Naturally, any other rolling system may be envisaged (balls or similar elements). Similarly, the wheels may be interchangeable and/or retractable depending on use.

In the exemplary embodiment of FIGS. 2 and 3, the oxygen tank 1 and a first portion 2 of a first heating and vaporization coil are placed in the bottom portion of the casing 3 while the second portion 12 of the first heating and vaporization coil is placed in the top portion of the casing 3, above the tank 1. A second coil 102 for heating the gaseous phase is placed concentrically inside the second top portion 12 of the first coil.

The first bottom portion 2 of the first coil is situated at the face called “front face” of the casing 3 that is situated substantially in line with the zone 19 for resting on the ground while the tank 1 is situated close to the face called the “rear face” of the casing 3, that is substantially in line with the rollers 5 and the top grip 11.

In the variant embodiment of FIG. 6, the first bottom portion 2 of the first coil is, on the other hand, situated at the “rear” face of the casing 3 while the tank 1 is situated close to the “front” face of the casing 3.

Naturally, the invention is not limited to the number of coils and to the relative positions of the latter described hereinabove.

In all cases, the structure of the device and in particular of the pedestal 4 and the arrangement of the heating circuits and of the tank 1 inside it provides an optimal balance of the device on its wheels 5 and particularly an optimal positioning of the centre of gravity of the assembly. The rolling device has great manoeuvrability which is characterized by a light feel in terms of weight during its ambulation (the centre of gravity is relatively close to the wheels 5). The balance obtained greatly limits the risks of overturning by tipping the assembly.

The device may also comprise conventionally a system of regulating the flow of oxygen delivered to the user comprising an operating button 18. Preferably, the operating button 18 for regulating the delivered flow is placed in the top portion of the casing 3 and is consequently perfectly oriented and positioned for use in a seated or standing position of the user.

The casing 3 or cover comprises aeration holes necessary for the correct ventilation of the heaters 2, 12. The aeration holes (not shown in the figures) are preferably situated in the rear zone of the casing 3, that is to say on the side opposite to the front zone likely to sustain impacts during normal use and preferably over the whole length of the heaters. For this reason, the front zone of the casing 3 is preferably solid to provide its rigidity.

The circuit for filling the cryogenic tank 1 of the device conventionally comprises a fluidic connection member 14 such as a male or female filling connector designed to be connected to a combined (female/male) connector of a liquid oxygen reserve. The fluidic connection member 14 is situated in the bottom portion of the device, more precisely in the bottom portion of the casing 3 designed to come facing the pedestal 4 (see FIG. 7).

Conventionally, the fluidic connection member 14 (connector) is shaped in order to be connected, in a filling direction D, with a matching connector of a liquid oxygen reserve. That is to say that, to fill the transportable device, the user must press the latter against the reserve in the filling direction D to make it possible to open the filling connectors. For example, the bottom portion of the portable device comprises the connection connector 14 and is pressed downwards on a top surface of the fixed reserve.

Accordingly, the fluidic connection connector 14 is oriented in this filling direction D (see FIG. 7 in particular).

To fill the device, the user must, at the same time as opening the filling connector (pressing on the reserve), open the venting valve 20 of the transportable device. Specifically, the portable device comprises a venting valve 20 capable of connecting the inside of the tank 1 with the outside. Opening the venting valve 20 makes it possible to release to the outside the pressurized gas of the tank 1, which, by pressure balancing, causes liquid to enter the tank 1 from the reserve via the filling connector 14.

The venting valve 20 is opened and closed by the user by means of a movable control member that can be actuated manually.

According to a particularly advantageous feature of the device, the member for controlling the venting valve 20 is formed relative to the casing and/or relative to the venting valve 20 so that, in its movement from the closed position to the open position, the control member describes a movement having at least one component or one force oriented substantially towards the inside of the casing and/or in the filling direction D.

Preferably, this movement of the control member generates a force on the device oriented mostly towards the inside of the casing and/or in the filling direction D. That is to say that a large and preferably major fraction of the force for opening the venting valve 20 is oriented in the direction of opening the filling connector.

This kinematic arrangement greatly simplifies the hand movements and coordination of the movements of the user during the operation of filling the portable device because opening the venting valve 20 also helps to keep the portable device on the reserve in the direction D of opening the filling connector.

The actuation member may be connected to the venting valve 20 via a system for transmitting movement that may contribute or provide a force towards the inside of the casing and/or in the filling direction D.

FIG. 10 illustrates an example of an actuation member of the venting valve 20. In FIG. 10, only a (central) portion of the casing 3 is shown schematically.

The member for controlling the venting valve 20 comprises a lever 21 which may be articulated relative to the casing 3. The lever 21 may also be movable or not movable in translation relative to the casing 3.

More precisely, the lever 21 may be articulated about an articulation shaft 23, the lever 21 furthermore being connected to the stem 24 for controlling the opening/closure of the venting valve 20. As shown in FIG. 22, the control stem 24 is for example fixedly attached to a valve element 124 designed to interact with a seat 224 of the valve 20 to close off or open a fluid passageway between an inlet 324 and an outlet 524.

The stem 24 for controlling the venting valve 20 is, for example, movable in translation inside a tubular sleeve 424 attached to the valve 20 and hence attached relative to the casing 3. The articulation shaft 23 common to the lever 21 and the control stem 24 may thus be free in translation with the said stem 24. The lever 21 has a cam profile 123 capable of interacting with one end of the sleeve 424. In this manner, the rotation of the lever 21 about its articulation shaft 23 generates a translation of the control stem 24 in the direction of opening or closing the valve, depending on the direction of rotation of the lever 21.

Naturally, any other system for transmitting movement may be provided between the lever 21 and the valve 20. For example, the lever 21 could be articulated about an articulation shaft 23 that is fixed relative to the casing 3.

A link rod or equivalent system can transform the rotary movement of the lever 21 into a translation movement of the valve element 24, 124 of the venting valve 20.

More precisely, the articulation shaft 23 and the control stem 24 are mechanically connected so that the pivoting of the lever 21 towards the inside of the casing 3 (arrow R, FIG. 14) causes the venting valve 20 to open (for example pulling on the control stem 24 fixedly attached to the valve 20).

Conversely, the rotation of the lever 21 towards the outside of the casing 3 causes the valve 20 to close.

The bottom end of the lever 21 interacts with a system for immobilizing the lever 21 that is removable and switchable between a position allowing the rotation of the lever 21 (for the opening of the venting valve 20) and a position preventing the rotation of the lever 21 (in a closed position of the valve 20).

For example, the bottom end 29 of the lever 21 is fixedly attached to a head 2121 comprising a groove 1221 in the shape of an L whose main branch is oriented substantially towards the inside of the casing 3 and perpendicularly to the vertical axis of the casing 3. The foot of the L formed by the groove 1221 (secondary branch) is, for its part, substantially perpendicular to the main branch of the L.

A stop 30 fixedly attached to the casing 3 or a fixed portion is housed movably in the groove 1221 of the head 121 of the end of the lever 21. When the stop 30 is situated in the secondary branch of the groove 1221, it prevents the bottom end 29 of the lever 21 from moving in the direction R of opening the valve 20 (FIG. 13). On the other hand, when the stop 30 is moved into the main branch of the groove 1221, it allows a limited rotation of the lever 21 (the head 2121 may slide around the stop 30 along the main branch). Accordingly, the stop 30 may be connected to a gripping portion 31 protruding from the casing 3 to be actuated by the user (for example in translation in a direction T parallel to the secondary branch 1221 of the groove, see FIG. 17). Preferably, at least one return element (not shown) such as a spring is provided so as by default to force the stop 30 into the position of preventing the lever 21 from rotating.

FIGS. 18 and 19 illustrate a variant embodiment of the member for controlling the venting valve 20. More precisely, the pivoting lever 21 of FIGS. 9 to 17 is replaced by a sleeve 121 sliding around at least one portion (preferably a central portion) of the casing 3 between a top, closed position of the venting valve 20 and a bottom, open position of the valve 20. The sleeve 121 may be formed, for example, from a movable portion of the casing 3 or from a part fitted to the latter. The sleeve is connected, for example, via a shaft and/or an articulation system 25 to the stem of the valve 20. As hereinabove, the device preferably comprises a return element forcing the sleeve 121 towards its top position.

It is easily understood that the member for actuating the venting valve 20 according to the invention (pivoting lever 21 or sliding sleeve 121) is ideally incorporated into a zone for gripping the device when it is filled. Specifically, to open the venting valve, the user may clasp the apparatus with both hands while pressing naturally on the lever 21 (or the sleeve 121). This movement to open the venting valve 20 coincides with the movement of pressing the device onto the reserve in order to open the filling connectors 14 (in the filling direction D).

These arrangements simplify the hand movements and coordination of the movements for the user during the filling operation and approximately halve the filling force by the patient due to the possibility of using both his hands.

FIG. 20 illustrates yet another variant embodiment of the venting valve control member in which the pivoting lever of FIGS. 9 to 16 is replaced by a button 221 capable of being moved in translation by pressing inwards. The button 221 is fixedly attached to a shaft 26 connected to the venting valve 20 via a mechanism for transmitting movement of the pitman type (rod 27, articulation 28). The mechanism for transmitting movement transforms a translation movement of the button 221 towards the inside of the casing 3 into a movement for opening the valve 20. In this non-limiting example, the valve 20 is of the type opened by the rotation of a shaft (a quarter turn for example). The button 221 is incorporated into the casing 3 or cover and may be pressed towards its position for opening the valve 20 by a spring 33. As a variant, the action of the spring 33 may be replaced by the automatic return action of the valve 20.

The button 221 is preferably situated in the top portion and/or on the side of the casing 3. In this manner, the pressing force on the button 221 generates a force on the device in the filling direction D which contributes to the opening of the filling connectors 14.

As previously, the natural positioning of the hands on all the ergonomic zones for grasping the device allow the forces to be aligned in the axis D of the filling connector. This limits the effort of the patient in order to hold the system during the filling phases and also helps to reduce premature wear of the filling connectors.

FIG. 21 illustrates yet another variant embodiment of the venting valve control member which differs from the embodiment of FIG. 9 in that the pivoting lever 21 is articulated at its bottom end (rotation axis 200), the lever 21 being operated by its top end. Thus, in the rest position (venting valve closed), the lever 21 substantially hugs the surface of the casing 3. The top end of the lever 21 may interact by elastic deformation (clip) or similar element with the casing 3 to form a stable rest position.

To open the venting valve 20, the user pulls the top end of the lever 21 towards the outside of the casing 3 and pivots it downwards in the filling direction D (rotation R, FIG. 21). In the open position of the venting valve 20, the lever 21 protrudes substantially perpendicularly to the surface of the casing 3. In addition to the advantages of the other variants hereinabove, in this embodiment, the opening of the venting valve 20 is indicated explicitly by the protruding lever 21. This further reduces the risk of accidental opening or forgetting to close the venting valve 20 because the user is immediately aware thereof.

The member for actuating the venting valve 20 is preferably incorporated into the surface of the casing 3 in order to protrude slightly or not at all in the rest position (valve 20 closed). In this manner, accidental openings of the venting valve 20 are prevented.

The casing 3 or the device in its entirety may be covered by a removable protective system, for example made of cloth. This protective system may be fitted with zones for storing canulae or any other object. The central grip 13 may be placed close to the member 21 for opening the venting valve 20 in order to offer, in one and the same zone, the functionalities for carrying, measuring the level and opening the venting valve.

1. Transportable device for storing and delivering oxygen comprising a casing (3) containing a cryogenic tank (1) designed to contain liquid oxygen, a heating circuit connected to the tank (1) comprising at least one member (2, 12) for heating/vaporizing the oxygen originating from the tank (1) for the purpose of its being supplied to a user, a circuit for filling the cryogenic tank (1) comprising a fluidic connection member (14) such as a male or female filling connector designed to be connected, in a filling direction (D), to a matching connector of a liquid oxygen reserve, a venting valve (20) connected inside the tank (1), a manually actuated movable member (21, 121, 221) for controlling the venting valve (20), the control member (21, 121, 221) being movable relative to the casing (3) for actuating the valve (20) via a system (23, 24; 25; 26 to 28) for transmitting movement between closed and open positions of the venting valve (20), characterized in that, in its movement from the closed position to the open position, the control member (21, 121, 221) describes a movement having at least one component oriented substantially towards the inside of the casing (3) and/or in the filling direction (D).

2. Device according to claim 1, characterized in that, in its actuation from the closed position to the open position, the control member (21, 121, 221) and/or the system (23, 24; 25; 26 to 28) for transmitting movement generates a force on the device having at least one component oriented in the filling direction (D).

3. Device according to claim 1, characterized in that, in its movement from the open position to the closed position, the control member (21, 121, 221) describes a movement oriented substantially towards the outside of the casing (3) and/or opposite to the filling direction (D).

4. Device according to claim 1, characterized in that the control member (21, 121, 221) is movable in rotation and/or in translation relative to the casing (3).

5. Device according to claim 1, characterized in that the control member (21, 121, 221) comprises a lever (21) articulated relative to the casing (3).

6. Device according to claim 5, characterized in that the lever (21) is articulated relative to the casing (3) at a first end (23) and comprises a second, free end (29).

7. Device according to either claim 5, characterized in that the lever (21) is connected to the venting valve (20) by a system for transmitting movement (24) in order to form a lever arm for actuating the said valve (20) when the lever (21) is rotated.

8. Device according to claim 5, characterized in that it comprises a removable element (30) for immobilizing the movable lever (21) between a position allowing the rotation of the lever (21) and a position preventing the rotation of the lever (21).

9. Device according to claim 6, characterized in that it comprises a removable element (30) for immobilizing the movable lever (21) between a position allowing the rotation of the lever (21) and a position preventing the rotation of the lever (21), and characterized in that the removable element (30) for immobilizing the lever (21) comprises a stop (30) that can be moved relative to the casing (3) capable of interacting or not interacting with the second end (29) of the lever (21), the movable stop being connected to a gripping portion (31).

10. Device according to claim 8, characterized in that it comprises a return member forcing the means (30) for immobilizing the lever (21) to the position preventing the rotation of the lever (21).

11. Device according to claim 1, characterized in that the control member (21, 121, 221) comprises a sleeve (121) capable of sliding around at least a portion of the casing (3) between high and low positions corresponding respectively to a closure and an opening of the venting valve (20), the high and low positions being defined relative to the upper and lower portions of the casing (3), the device also comprising a return member forcing the sleeve (121) to its high position.

12. Device according to claim 1, characterized in that the casing (3) comprises at least one portion flared in the direction of its lower portion and in that the control member (21, 121, 221) is situated at least partially at the level of the flared portion.

13. Device according to claim 1, characterized in that the fluidic connection member (14) is situated in the lower portion of the device.

14. Device according to claim 1, characterized in that the fluidic connection member (14) is situated in the lower portion of the casing (3) designed to come facing the pedestal (4).

15. Device according to claim 1, characterized in that the fluidic connection member (14) forming a connector for filling the tank (1) is oriented in the filling direction (D).

16. Device according to claim 2, characterized in that, in its movement from the open position to the closed position, the control member (21, 121, 221) describes a movement oriented substantially towards the outside of the casing (3) and/or opposite to the filling direction (D).

17. Device according to claim 2, characterized in that the control member (21, 121, 221) is movable in rotation and/or in translation relative to the casing (3).

18. Device according to claim 3, characterized in that the control member (21, 121, 221) is movable in rotation and/or in translation relative to the casing (3).

19. Device according to claim 2, characterized in that the control member (21, 121, 221) comprises a lever (21) articulated relative to the casing (3).

20. Device according to claim 3, characterized in that the control member (21, 121, 221) comprises a lever (21) articulated relative to the casing (3).
